(19) United States
(12) Patent Application Publication
(10) Pub. No.: US 2025/0377837 A1
(43) Pub. Date: Dec. 11, 2025

(54) STORAGE MEDIUM, PRINT JOB MANAGEMENT APPARATUS, AND PRINT JOB MANAGEMENT METHOD

(71) Applicant: Konica Minolta, Inc., Tokyo (JP)

(72) Inventor: Taisuke MINEMURA, Okazaki-shi (JP)

(21) Appl. No.: 19/226,240

(22) Filed: Jun. 3, 2025

(30) Foreign Application Priority Data
Jun. 5, 2024 (JP) 2024-091370

(51) Int. Cl. G06F 3/12

(52) U.S. Cl. CPC G06F 3/1207; G06F 3/1214; G06F 3/1259

(57) ABSTRACT

A non-transitory computer-readable storage medium stores a program causing a computer to cause a display to display progress statuses of print jobs related to ordered printed materials with respect to work plans and volumes of the print jobs on a same screen process step by process step in which the print jobs are located.

### CROSS-REFERENCE TO RELATED APPLICATIONS

The entire disclosure of Japanese Patent Application No. 2024-091370, filed on Jun. 5, 2024, is incorporated herein by reference in its entirety.

### BACKGROUND OF THE INVENTION

### Technical Field

The present invention relates to a storage medium, a print job management apparatus, and a print job management method.

### Description of Related Art

Various technologies for “visualization” of progress statuses of print jobs order-received by a printing company have been proposed.

For example, Japanese Unexamined Patent Publication No. 2023-60180 describes that graphics corresponding to process steps of a process and graphics that complement progress statuses, such as “currently in process”, for respective progress statuses are used to display statuses of ordered jobs in the same process step at aligned positions so that the statuses can be easily understood.

### SUMMARY OF THE INVENTION

However, in the technology described in Japanese Unexamined Patent Publication No. 2023-60180, in a case where a print job having a delay in a certain process step is found, an worker cannot grasp information on the work volume of each print job necessary for modification of a work plan. It takes time and effort to collect the information and grasp the statuses at the time of modification of the work plan. As a result, a determination error or a determination delay occurs in the modification of the work plan, and the productivity significantly decreases.

An object of the present invention is to enable quick modification of a work plan for a delayed print job.

To achieve at least one of the abovementioned objects, according to an aspect of the present invention, a non-transitory computer-readable storage medium reflecting one aspect of the present invention stores a program causing a computer to cause a display to display progress statuses of print jobs related to ordered printed materials with respect to work plans and volumes of the print jobs on a same screen process step by process step in which the print jobs are located.

According to an aspect of the present invention, a print job management apparatus reflecting one aspect of the present invention includes a hardware processor that causes a display to display progress statuses of print jobs related to ordered printed materials with respect to work plans and volumes of the print jobs on a same screen process step by process step in which the print jobs are located.

According to an aspect of the present invention, a print job management method reflecting one aspect of the present invention is performed by a computer, and includes causing a display to display progress statuses of print jobs related to ordered printed materials with respect to work plans and volumes of the print jobs on a same screen process step by process step in which the print jobs are located.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 illustrates an example of the overall configuration of a print job management system;

FIG. 2 is a block diagram illustrating a functional configuration of a management server;

FIG. 3 illustrates an example of data storage of a received order information DB;

FIG. 4 illustrates an example of data storage of a job management DB;

FIG. 5 is a flowchart illustrating the flow of a job management screen display process that is performed by a controller shown in FIG. 2;

FIG. 6 illustrates the initial state of a job management screen;

FIG. 7 illustrates an example of the job management screen on which progress statuses and volumes of only delayed jobs are displayed;

FIG. 8 illustrates an example of the job management screen on which the progress status and the volume of only a selected specific delayed job are displayed;

FIG. 9 illustrates an example of the job management screen on which the progress statuses and the volumes of other jobs each of which is in the same process step as or in a process step immediately before or after the process step of the specific delayed job and is progressing smoothly are displayed;

FIG. 10 illustrates an example of the job management screen on which the progress statuses and the volumes of the other jobs each of which is in the same process step or in a process step immediately before or after the process step of the specific delayed job and is progressing smoothly with respect to a work plan are sorted and displayed in order of candidate for allocation of personnel and/or machines to the delayed job;

FIG. 11 illustrates an example in which states and spare times before and after change of a work plan are displayed in a pop-up manner;

FIG. 12 is a flowchart illustrating the flow of a delay notification process that is performed by the controller shown in FIG. 2; and

FIG. 13 illustrates an example of the job management screen on which a warning mark is displayed.

### DETAILED DESCRIPTION

Hereinafter, one or more embodiments of the present invention will be described with reference to the drawings. However, the scope of the invention is not limited to the disclosed embodiments or the illustrated examples.

### [Configuration of Print Job Management System]

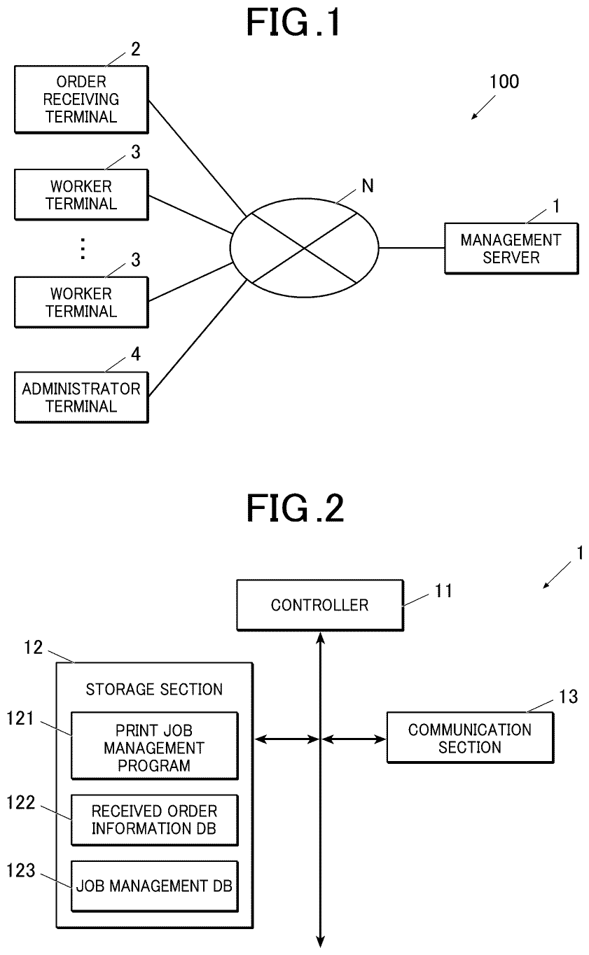

FIG. 1 illustrates an example of the overall configuration of a print job management system 100 in the present embodiment. The print job management system 100 is a system installed in a printing company, especially a printing company that primarily handles on-demand printing. As illustrated in FIG. 1, the print job management system 100 includes a management server 1, an order receiving terminal 2, a worker terminal(s) 3, and an administrator terminal 4. The order receiving terminal 2, the worker terminal 3, and the administrator terminal 4 can be connected to the management server 1 via a communication network N such as a LAN (Local Area Network). Regarding each terminal device, the number of terminal devices is not particularly limited.

The management server 1 is a print job management apparatus that manages jobs (print jobs) related to ordered printed materials.

As shown in FIG. 2, the management server 1 includes a controller 11 (hardware processor), a storage section 12, a communication section 13, and the like.

The controller 11 includes at least one central processing unit (CPU), a random access memory (RAM), and the like. The CPU of the controller 11 reads a system program and a print job management program 121 stored in the storage section 12, loads the programs to the RAM, and executes various processes including a job management screen display process, described later, in cooperation with the loaded programs.

The storage section 12 includes a nonvolatile semiconductor memory, a hard disk drive (HDD), and the like. The storage section 12 stores the system program of the management server 1 and various process programs such as the print job management program 121, data necessary for executing the programs, and the like. In the present embodiment, the print job management program 121 will be described as a Web application program for job management.

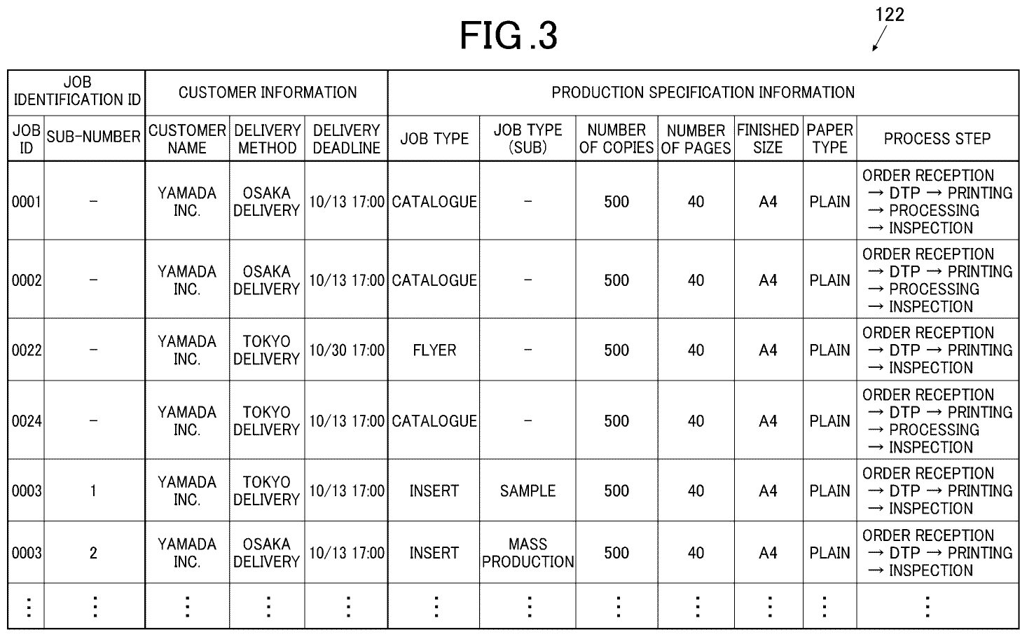

The storage section 12 is provided with a received order information database (DB) 122. As illustrated in FIG. 3, in the received order information DB 122, job identification information, customer information, production specification information, and the like on each job related to an ordered printed material are associated with one another and stored as received order information. The received order information is input from the order receiving terminal 2 by a person in charge of order reception. Alternatively, data (file) in which the received order information is registered may be imported by the order receiving terminal 2 and transmitted to the management server 1.

The job identification information is information for identifying a job related to a printed material order-received by a printing company, and includes a job ID and a sub-number. The job ID is ID information (number) assigned to a job for identifying a job related to an ordered printed material. The sub-number is an identification number assigned to each of a plurality of small jobs (components) when an ordered job is composed of a plurality of small jobs.

The customer information includes information on a customer name, a delivery method, a delivery deadline, and so forth. The customer name is the name of an orderer of an ordered printed material. The delivery method is information indicating a delivery method of an ordered printed material. In the present embodiment, the delivery method is described by the name of a delivery company used for delivery. The delivery deadline is information indicating a delivery deadline of an ordered printed material.

The production specification information is information indicating production specifications of an ordered printed material, and includes information on items such as a job type, the number of copies, the number of pages, a finished size, a paper type, and process steps, for example. The job type is, for example, information indicating the type of a printed material to be produced by a job, such as a catalog, an insert, or a flyer. The process steps are process steps necessary for producing an ordered printed material. The process steps include, for example, order reception, DTP, printing, processing, and inspection. Note that the process steps may be input from the order receiving terminal 2 when received order information is input, or may be input from the administrator terminal 4 when a work plan is input.

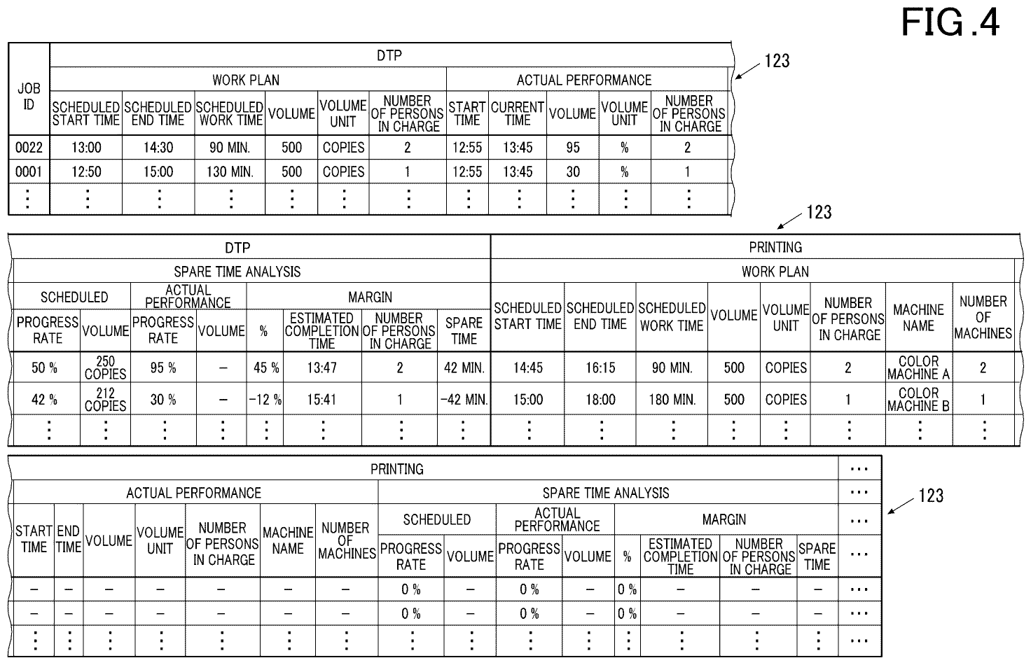

The storage section 12 is provided with a job management DB 123. In the job management DB 123, as shown in FIG. 4, the job ID of each ordered and registered job is associated with work plan information, actual performance information (progress information), spare time analysis information, and the like of each process step, and stored as job management information. Among the job management information, the work plan information is input from the administrator terminal 4 by the chief administrator of the entire printing factory or the chief administrator (administrator) of each process step. The actual performance information is input from the worker terminal 3 by the worker of each process step. The spare time analysis information is calculated by the controller 11 on the basis of the work plan information and the actual performance information. Note that the actual performance information may be input by reading a barcode other than using a keyboard or a touch screen.

The work plan information includes information on items such as a scheduled start time, a scheduled end time, a scheduled work time, a volume, and the number of persons in charge. The work plan information about a process step using a machine (machine such as an image forming apparatus or a post-processing device), such as a printing process step or a processing process step, includes information on items such as a machine name and the number of machines. The volume is a value representing the amount of work for a job. Examples thereof include the number of print sheets, the number of copies, the number of data pages, and the number of processing types. The volume is automatically input on the basis of received order information by selecting a volume unit.

The actual performance information includes information on items such as a start time, a current time, a volume, and the number of persons in charge. The work plan information about a process step using a machine, such as a printing process step or a processing process step, includes information on items such as a machine name and the number of machines.

The spare time analysis information includes information on items such as a progress rate and a volume under “Scheduled”, a progress rate and a volume under “Actual Performance”, a progress rate, an estimated completion time, the number of persons in charge and a spare time under “Margin”. The spare time is calculated by, for example, a time difference obtained by subtracting the “estimated completion time” of the spare time analysis information from the “scheduled end time”.

The storage section 12 also stores login information (e.g., user ID and password), a user name, and whether administrator privileges are granted, about each user (administrator, worker, receptionist, etc.) registered in the print job management system 100. The user ID is used as a worker ID or an administrator ID.

The communication section 13 performs communication control for communicating with the order receiving terminal 2, the worker terminal 3, and the administrator terminal 4 via the network N in a wired or wireless manner.

The order receiving terminal 2 is a terminal device for registering received order information from the orderer in the management server 1. For example, the order receiving terminal 2 receives input of information on each item in the received order information DB 122 regarding an ordered printed material by the orderer, and transmits the input received order information to the management server 1. As the order receiving terminal 2, for example, a tablet terminal, a PC (Personal Computer), a smartphone, etc. can be applied. The order receiving terminal 2 is provided with a web browser, and displays web screens such as an received order information input screen (not shown) provided by the management server 1.

The worker terminal 3 is a terminal device (display part or display) for a worker who performs work of each process step of a job to check information on and the progress status of a job related to an ordered printed material and also to input actual performance information. As the worker terminal 3, for example, a tablet terminal, a PC (Personal Computer), a smartphone, etc. can be applied. The worker terminal 3 is provided with a web browser, and displays web screens such as a progress input screen (not shown) and a job management screen for a worker (not shown) provided by the management server 1.

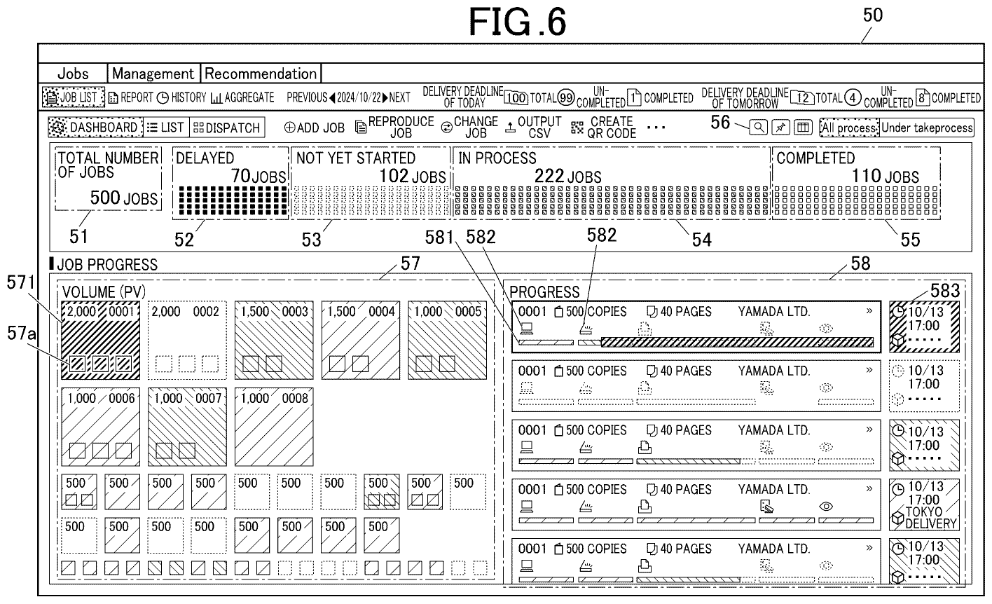

The administrator terminal 4 is a terminal device (display part or display) for an administrator who manages the entire job or each process step to input work plan information on a job related to an ordered printed material and also to check information on the job related to the ordered printed material and the progress status. As the administrator terminal 4, for example, a tablet terminal, a PC (Personal Computer), a smartphone, etc. can be applied. The administrator terminal 4 is provided with a web browser, and displays web screens such as a job management screen 50 (see FIG. 6) for an administrator provided by the management server 1.

### [Operation of Print Job Management System]

Next, operation of the print job management system 100 in the present embodiment will be described.

The controller 11 of the management server 1 executes the following processes in cooperation with the print job program 121.

When the controller 11 of the management server 1 receives a login request from the order receiving terminal 2, the worker terminal 3, or the administrator terminal 4 (terminal device) via the communication section 13, the controller 11 performs login authentication. The controller 11 stores and manages the terminal ID of the logged-in terminal device, the ID of the logged-in user (worker ID, administrator ID, etc.) in the RAM, the storage section 12, or the like.

When received order information is input from the order receiving terminal 2, the controller 11 registers the input received order information in the received order information DB 122. When work plan information is input from the administrator terminal 4, the controller 11 registers the input work plan information in the job management DB 123. When actual performance information is input from the worker terminal 3, the controller 11 registers the input actual performance information in the job management DB 123, and also calculates and registers spare time information in the job management DB 123. When change of the work plan information is input from the administrator terminal 4, the controller 11 registers the work plan information after the change in the job management DB 123, and also recalculates and registers the spare time information in the job management DB 123.

When the controller 11 receives a request to display a screen from a terminal device, the controller 11 causes the terminal device, which has made the request, to display the requested screen on the basis of the received order information DB 122 and the job management DB 123. When information is registered or updated in the received order information DB 122 or the job management DB 123, the controller 11 updates the screen being displayed on each terminal device on the basis of the registered or updated information.

Hereinafter a job management screen display process will be described. The job management screen display process is performed by the management server 1 upon receipt of a request to display the job management screen 50 from the administrator terminal 4 via the communication section 13.

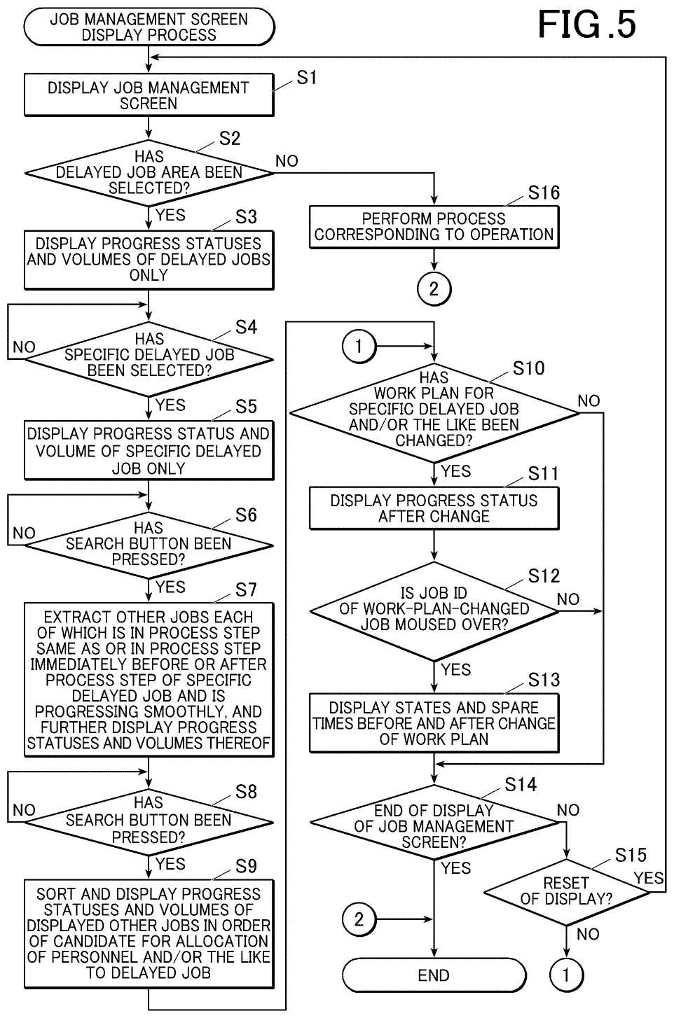

FIG. 5 is a flowchart illustrating the flow of the job management screen display process. The job management screen display process is performed by the controller 11 in cooperation with the print job management program 121 stored in the storage section 12.

First, the controller 11 causes the administrator terminal 4 that has transmitted the display request to display the job management screen 50 based on the job management information stored in the job management DB 123 (Step S1).

The controller 11 causes the administrator terminal 4, which has transmitted/made the display request, to display the job management screen 50 on the basis of the received order information in the received order information DB 122 and the job management information in the job management DB 123.

FIG. 6 illustrates the initial state of the job management screen 50. The job management screen 50 is a screen capable of displaying the progress statuses and the volumes of jobs with respect to their respective work plans process step by process step. On the job management screen 50, all process steps are display targets in the initial state, but by specifying a process step by operating a search button 56, jobs located in the specified process step can be made to be display targets.

In the upper part of the job management screen 50, a total job number field 51, a delayed job area 52, a not-yet-started job area 53, a job-in-process area 54, and a completed job area 55 are provided. The total job number field 51 displays the total number of jobs in a process step as a display target. The delayed job area 52 displays the number of jobs in the delayed state in the process step as the display target with a numerical value and dots. The not-yet-started job area 53 displays the number of jobs in the not-yet-started state in the process step as the display target with a numerical value and dots. The job-in-process area 54 displays the number of jobs in process in the process step as the display target with a numerical value and dots. The completed job area 55 displays the number of completed jobs in the process step as the display target with a numerical value and dots.

The delayed job is a job that is delayed with respect to its work plan, and is a job that is expected not to be finished at (by) the “scheduled end time” in the work plan information. In the present embodiment, the delayed job is a job about which the “estimated completion time” in the spare time analysis information in the job management DB 123 is later than the “scheduled end time” in the work plan information. In other words, the delayed job is a job having a minus (negative) spare time.

A volume display area 57 is provided at the lower left of the job management screen 50. In the volume display area 57, information indicating the volume of each job located in the process step as the display target is displayed. In the present embodiment, boxes 571, which are icons representing jobs, are displayed as (pieces of) information indicating the volumes of jobs. The numerical value at the upper left of each box 571 indicates the size of the volume. In the present embodiment, the number of print sheets (PV; print volume) is displayed as the volume. The numerical value at the upper right of each box 571 indicates a job ID. The size of each box 571 corresponds to the size of the volume. For example, in FIG. 6, large boxes indicate that the number of print sheets is 501 or more, medium boxes indicate that the number of print sheets is 101 to 500, and small boxes indicate that the number of print sheets is 100 or less. The volumes corresponding to the large boxes, the medium boxes, and the small boxes can be appropriately set by the user.

Small boxes 57a may be included in a box 571. The boxes 57a indicate that one job includes a plurality of small jobs (components). The number of components is also an index indicating the volume. The arrangement order of the boxes 571 is synchronous with the arrangement order of jobs in a progress status display area 58 at the lower right of the job management screen 50, but may be asynchronous therewith depending on the setting.

In the progress status display area 58, information indicating the progress status of each job with respect to the work plan, the job being located in the process step as the display target, is displayed. In the present embodiment, a progress status bar 581 for each job is displayed as the information indicating the progress status of each job. The numerical value at the upper left of the progress status bar 581 for each job indicates a job ID. Next to the job ID, the number of copies, the number of pages, the name of the orderer, and the like are displayed. The progress status bar 581 indicates, with a bar, the progress of each process step planned in the work plan. For process steps that are not planned in the work plan, the progress status bar 581 is not displayed. The progress status bar 581 for each process step is displayed in association with an icon 582 representing the process step. The progress status bar 581 for each process step is displayed in a different color according to the progress status. In the present embodiment, not-yet-started, in-process, completed, and delayed are displayed in gray, blue, green, and red, respectively. The dots shown in the upper part of the job management screen 50 representing the number of jobs for each progress status and the boxes 571 shown in the volume display area 57 are also displayed in gray for not-yet-started, blue for in-process, green for completed, and red for delayed.

Delivery-related Information 583 is displayed on the right side of each progress status bar 581. In the delivery-related information 583 illustrated in FIG. 6, a delivery deadline is displayed at the upper part, and a delivery method is displayed at the lower part.

The information indicating the progress status of each job is displayed, for example, in order from the earliest delivery deadline. All pieces of the information indicating the progress status of each job can be displayed by vertical scroll on the administrator terminal 4.

In the progress status bars 581, the boxes 571, and the delivery-related information 583 in FIG. 6 to FIG. 11 and FIG. 13, dotted lines indicate gray. Further, hatching with oblique lines from the upper left to the lower right indicates blue. Further, hatching with thin oblique lines from the upper right to the lower left indicates green. Further, hatching with thick oblique lines from the upper right to the lower left indicates red. Further, in the dots in the delayed job area 52, the not-yet-started job area 53, the job-in-process area 54, and the completed job area 55 of FIG. 6 to FIG. 11 and FIG. 13, dotted lines indicate gray. Further, oblique lines indicate blue. Further, white indicates green. Further, black indicates red.

Thus, it is possible to simultaneously display, on the job management screen 50 process step by process step, the progress status of each job with respect to a work plan and the volume of the job located in a process step. Therefore, the administrator can easily grasp whether a delayed job has occurred in a certain process step. Further, in a case where a delayed job has occurred, the progress statuses and the volumes of other jobs located in the same process step are displayed. Therefore, the administrator can quickly and easily modify work plans, for example, to allocate a person(s) and/or a machine(s) for the other job(s) to the delayed job.

Next, the controller 11 determines whether an operation to select the delayed job area 52 has been performed on the administrator terminal 4 that has transmitted the display request (Step S2).

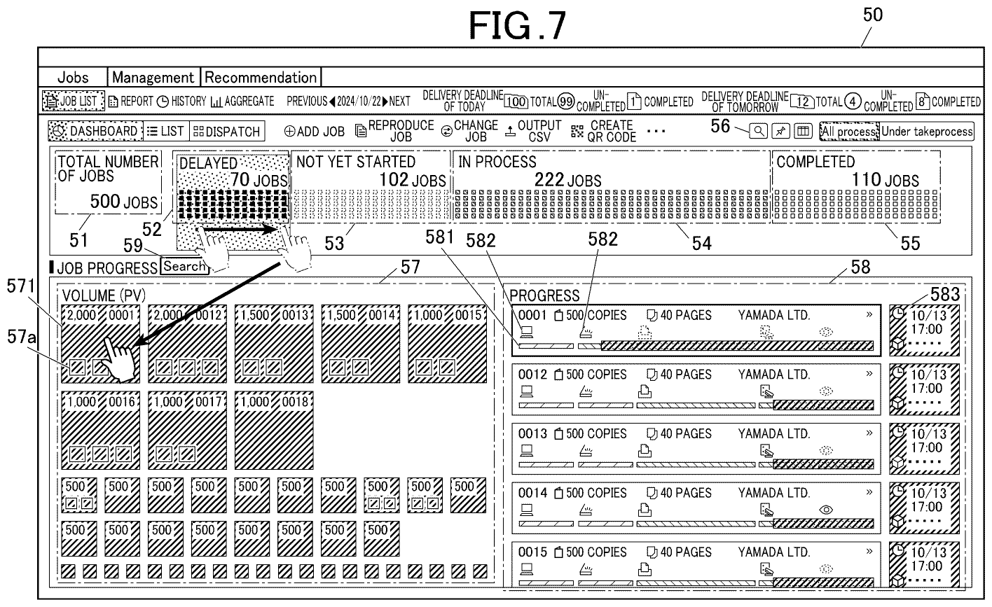

For example, as illustrated in FIG. 7, when receiving, from the administrator terminal 4 that has transmitted the display request, information indicating that the delayed job area 52 has been dragged with a finger or a mouse, the controller 11 determines that an operation to select the delayed job area 52 has been performed.

If the controller 11 determines that the operation to select the delayed job area 52 has been performed on the administrator terminal 4 that has transmitted the display request (Step S2; YES), the controller 11 proceeds to Step S3. In Step S3, the controller 11 causes the administrator terminal 4 that has transmitted the display request to display the job management screen 50 on which the progress statuses and the volumes of only delayed jobs in the process step as the display target are displayed (Step S3). Further, the controller 11 causes the job management screen 50 to display a search button 59.

As illustrated in FIG. 7, by displaying the job management screen 50 on which the progress statuses and the volumes of only delayed jobs are displayed, the administrator can easily grasp delayed jobs.

When the administrator grasps delayed jobs through the job management screen 50 shown in FIG. 6 or FIG. 7, the administrator instructs the worker(s) of the process step as the display target to register the current actual performances (progresses) of other jobs. This instruction may be given orally or may be given by push notification to the worker terminal 3 of each worker. The worker causes the worker terminal 3 to display a progress input screen for inputting the current actual performance, and inputs the actual performance (current status, such as not-yet-started, started or completed, and volume, such as the number of copies or percentage) in the process step in charge of the job in charge. When the actual performance is input, the worker terminal 3 transmits the input actual performance information to the management server 1 in association with the job ID. When the controller 11 receives the actual performance information via the communication section 13, the controller 11 updates the actual performance of the process step concerned of the job concerned in the job management DB 123 with the received actual performance information. Further, the controller 11 recalculates and updates the spare time of the process step concerned of the job whose actual performance information has been updated. Further, the controller 11 causes each terminal currently displaying the job management screen 50 to display the job management screen 50 based on the updated information.

Next, the controller 11 determines whether an operation to select a specific delayed job has been performed on the administrator terminal 4 that has transmitted the display request (Step S4).

For example, when receiving, from the administrator terminal 4 that has transmitted the display request, information indicating that one of the boxes 571 has been pressed with a finger or a mouse, the controller 11 determines that an operation to select a specific delayed job has been performed.

If the controller 11 determines that the operation to select a specific delayed job has not been performed on the administrator terminal 4 that has transmitted the display request (Step S4; NO), the controller 11 returns to Step S4.

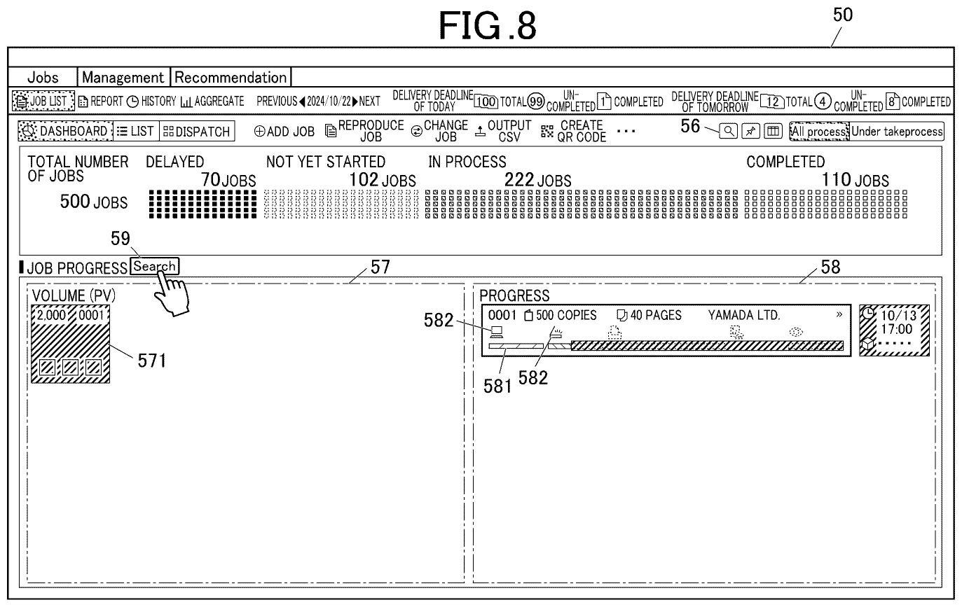

If the controller 11 determines that the operation to select a specific delayed job has been performed on the administrator terminal 4 that has transmitted the display request (Step S4; YES), the controller 11 proceeds to Step S5. In Step S5, as illustrated in FIG. 8, the controller 11 causes the administrator terminal 4 that has transmitted the display request to display the job management screen 50 on which the progress status and the volume of only the selected delayed job are displayed (Step S5).

Next, the controller 11 determines whether the search button 59 has been pressed on the administrator terminal 4 that has transmitted the display request (Step S6).

For example, when receiving information indicating that the search button 59 has been pressed on the administrator terminal 4 that has transmitted the display request, the controller 11 determines that the search button 59 has been pressed.

If the controller 11 determines that the search button 59 has not been pressed on the administrator terminal 4 that has transmitted the display request (Step S6; NO), the controller 11 returns to Step S6.

If the controller 11 determines that the search button 59 has been pressed on the administrator terminal 4 that has transmitted the display request (Step S6), the controller 11 proceeds to Step S7.

In Step S7, the controller 11 extracts, from the job management DB 123, other jobs each of which is in the process step same as or in a process step immediately before or after the process step of the specific delayed job and is progressing smoothly with respect to the work plan. The other jobs progressing smoothly with respect to their work plans are other jobs having no delay. The controller 11 causes the administrator terminal 4 that has transmitted the display request to display the job management screen 50 on which the progress statuses and the volumes of the extracted other jobs are further displayed (Step S7).

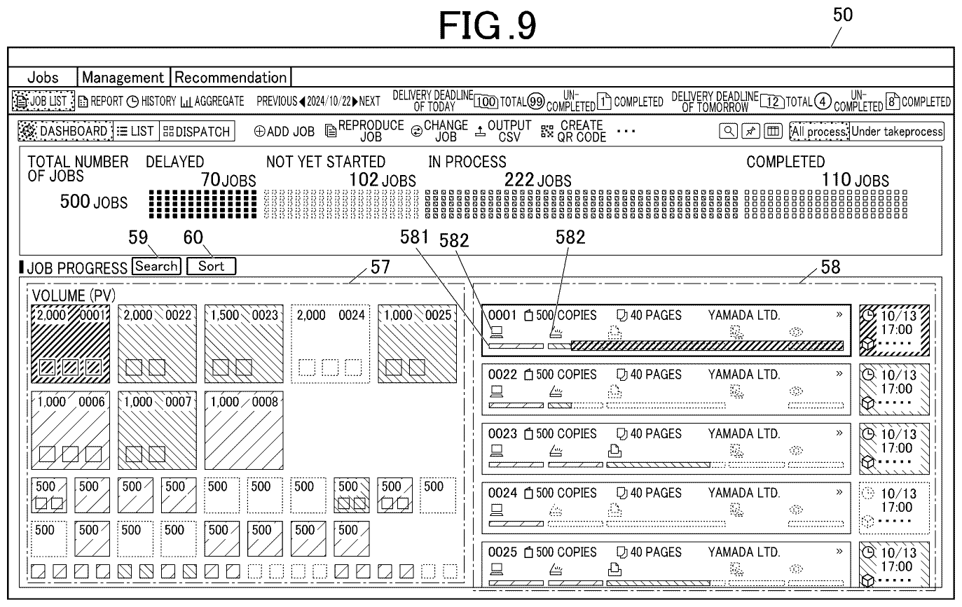

FIG. 9 illustrates an example of the job management screen 50 displayed in Step S7 on the administrator terminal 4 that has transmitted the display request. As shown in FIG. 9, on the job management screen 50, the progress statuses and the volumes of other jobs each of which is in the process step same as or in a process step immediately before or after the process step of the specific delayed job are displayed. Therefore, the administrator or the like can easily grasp other jobs that have a surplus capacity and whose personnel and/or machines can be allocated to the delayed job, and can quickly modify the work plan(s).

Note that in Step S7, the controller 11 causes a sort button 60 to be displayed on the job management screen 50. The sort button 60 is a button for making an instruction to sort the progress statuses and the volumes of the other jobs in order of candidate for allocation of personnel and/or machines to the delayed job.

Next, the controller 11 determines whether the sort button 60 has been pressed on the administrator terminal 4 that has transmitted the display request (Step S8).

For example, when receiving information indicating that the sort button 60 has been pressed on the administrator terminal 4 that has transmitted the display request, the controller 11 determines that the sort button 60 has been pressed.

If the controller 11 determines that the sort button 60 has not been pressed on the administrator terminal 4 that has transmitted the display request (Step S8; NO), the controller 11 returns to Step S8.

If the controller 11 determines that the sort button 60 has been pressed on the administrator terminal 4 that has transmitted the display request (Step S8; YES), the controller 11 proceeds to Step S9.

In Step S9, the controller 11 sorts and displays the other jobs extracted in Step S7 in order of candidate for allocation of personnel and/or machines to the delayed job on the basis of a predetermined condition. Examples of the condition for sorting the other jobs in order of candidate mentioned above include “(a process step in which a delayed job has occurred or a process step immediately before that) and (the status of not-yet-started or started) and (descending order of volume)”. Instead of descending order of volume, descending order of spare time in the process step may be used. Instead of descending order of volume, descending order of delivery deadline (in order from the furthest delivery deadline) may be used. In the job management DB 123 illustrated in FIG. 4, the job in the status of not-yet-started is a job whose start time under “Actual Performance” is not registered. The job in the status of started is a job whose progress rate under “Actual Performance” is 0%<Progress Rate<100%. The sort condition may be not an AND condition but an OR condition. The sort condition can be appropriately changed from the administrator terminal 4.

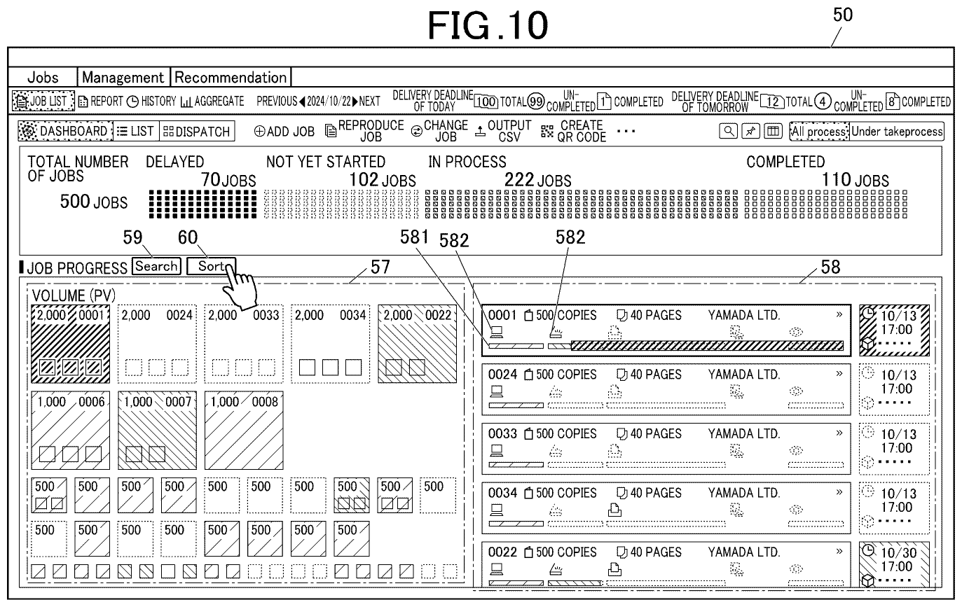

FIG. 10 illustrates an example of the job management screen 50 displayed in Step S9 on the administrator terminal 4 that has transmitted the display request. As illustrated in FIG. 10, on the job management screen 50, the progress statuses and the volumes of other jobs each of which is in the process step same as or in a process step immediately before or after the process step of the specific delayed job (job ID=0001) and is progressing smoothly with respect to the work plan are sorted and displayed in order of candidate for allocation of personnel and/or machines to the delayed job. Therefore, the administrator can more quickly access other jobs that have a surplus capacity and whose personnel and/or machines can be allocated to a delayed job, and quickly modify the work plan.

The administrator of a process step refers to, for example, the job management screen 50 shown in FIG. 9 or FIG. 10 and performs rescheduling. In the rescheduling, for example, the administrator allocates a person(s) and/or a machine(s) to a delayed job from other job(s). After the rescheduling, the administrator changes, on the administrator terminal 4, the number of persons in charge and/or the number of machines in the work plan information on the process step of the job for which the number of persons in charge and/or the number of machines have been changed.

When the change is input, the administrator terminal 4 transmits the changed item(s) and content(s) (change information) of the work plan information to the management server 1 in association with the job ID.

The controller 11 determines whether the work plan(s) for the specific delayed job and/or the like has been changed on the administrator terminal 4 that has transmitted the display request (Step S10).

The controller 11 determines whether the work plan for the specific delayed job and/or the like has been changed on the basis of whether the change information on the specific delayed job and/or the like has been received from the administrator terminal 4 that has transmitted the display request.

If the controller 11 determines that the work plan for the specific delayed job and/or the like has not been changed (Step S10; NO), the controller 11 proceeds to Step S14.

If the controller 11 determines that the work plan for the specific delayed job and/or the like has been changed on the administrator terminal 4 that has transmitted the display request (Step S10; YES), the controller 11 reflects the progress status after the change in the job management screen 50 that is being displayed (Step S11).

Upon receiving the change information, the controller 11 updates the contents of the item(s) of the work plan information of the process step concerned of the job concerned in the job management DB 123 according to the received change information. In addition, the controller 11 updates the job management DB 123 by recalculating the estimated completion time and the spare time of the process step concerned of the job for which the work plan information has been updated. The estimated completion time can be calculated from, for example, the work speed of the worker in charge after the change and the remaining amount of work (the number of copies×the number of pages). The work speed of each worker may be measured and stored in advance, or in a case where personnel have been allocated from other job(s) that is being performed, the work speed may be estimated from the actual performance of the other job(s). Further, the controller 11 causes each administrator terminal 4 currently displaying the job management screen 50 to update display of the job management screen 50 on the basis of the updated information. That is, the controller 11 reflects the progress status after the change in the job management screen 50 that is being displayed.

Next, the controller 11 determines whether the job ID of the job for which the work plan has been changed is moused over on the administrator terminal 4 that have transmitted the display request (Step S12).

The controller 11 determines whether the job ID of the job for which the work plan has been changed is moused over, on the basis of whether the controller 11 has received information indicating that the job ID of the job for which the work plan has been changed is moused over on the administrator terminal 4 that has transmitted the display request.

If the controller 11 determines that the job ID of the job for which the work plan has been changed is moused over (Step S12; YES), the controller 11 proceeds to Step S13.

In Step S13, the controller 11 causes the administrator terminal 4 that has transmitted the display request to display states and spare times of the job of the moused-over job ID before and after the change of the work plan. For example, the controller 11 extracts, from the job management DB 123, the record of the moused-over job ID, and causes the administrator terminal 4 that has transmitted the display request to display the states of a predetermined item(s) of the work plan information and the spare times before and after the change.

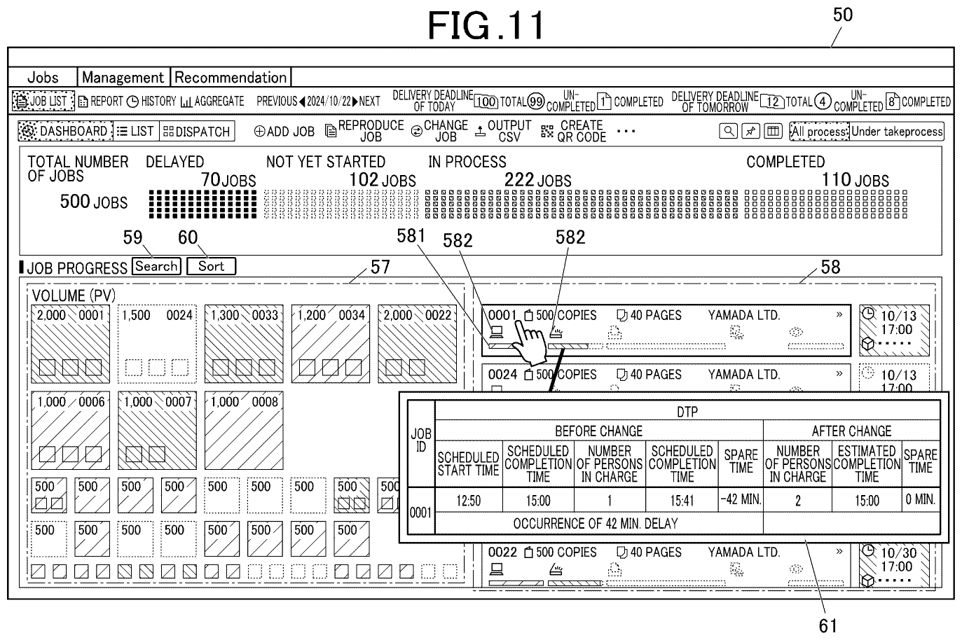

FIG. 11 illustrates an example of a screen 61 displayed in Step S13 on the administrator terminal 4 that has transmitted the display request. As shown in FIG. 11, on the screen 61, the states and the spare times before and after the change of the work plan, namely, change in state and change in spare time by the change of the work plan, are displayed. For example, as illustrated in FIG. 11, the scheduled start time, the scheduled completion time, the number of persons in charge, the estimated completion time and the spare time before the change of the work plan and the number of persons in charge, the estimated completion time and the spare time after the change of the work plan are displayed. Thus, the administrator can check the change of the work plan, and can also check whether the change of the work plan will result in meeting the originally scheduled completion time.

If the controller 11 determines that the job ID of the job for which the work plan has been changed is not moused over on the administrator terminal 4 that has transmitted the display request (Step S12; NO), the controller 11 proceeds to Step S14.

In Step S14, the controller 11 determines whether an instruction to end display of the job management screen 50 has been made on the administrator terminal 4 that has transmitted the display request (Step S14).

The controller 11 determines whether an instruction to end display of the job management screen 50 has been made on the basis of whether information indicating an end of display of the job management screen 50 has been received from the administrator terminal 4.

If the controller 11 determines that the instruction to end display of the job management screen 50 has not been made on the administrator terminal 4 that has transmitted the display request (Step S14; NO), the controller 11 proceeds to Step S15.

In Step S15, the controller 11 determines whether an instruction to reset display of the job management screen 50 has been made on the administrator terminal 4 that has transmitted the display request (Step S15).

The controller 11 determines whether an instruction to reset display of the job management screen 50 has been made on the basis of whether information indicating a reset of display of the job management screen 50 has been received from the administrator terminal 4 that has transmitted the display request. Resetting display of the job management screen 50 refers to restoring display of the job management screen 50 to the initial state.

If the controller 11 determines that the instruction to reset display of the job management screen 50 has been made on the administrator terminal 4 that has transmitted the display request (Step S15; YES), the controller 11 returns to Step S1.

If the controller 11 determines that the instruction to reset display of the job management screen 50 has not been made on the administrator terminal 4 that has transmitted the display request (Step S15; NO), the controller 11 returns to Step S10.

In Step S14, if the controller 11 determines that the instruction to end display of the job management screen 50 has been made on the administrator terminal 4 that has transmitted the display request (Step S14; YES), the controller 11 ends the job management screen display process.

In Step S2, if the controller 11 determines that an operation other than the operation to select the delayed job area 52 has been performed on the administrator terminal 4 that has transmitted the display request (Step S2; NO), the controller 11 performs a process corresponding to the operation performed on the administrator terminal 4 (Step S16), and ends the job management screen display process.

Thus, in the job management screen display process, by displaying the progress statuses and the volumes of jobs each of which is in the process step same as or in a process step immediately before or after the process step of the delayed job and is progressing smoothly with respect to the work plan, it is possible to quickly modify the work plan for the delayed print job.

Further, in order to reduce oversight of delayed jobs, the controller 11 performs a delay notification process at intervals of a predetermined time and notifies the administrator or the like of delayed jobs.

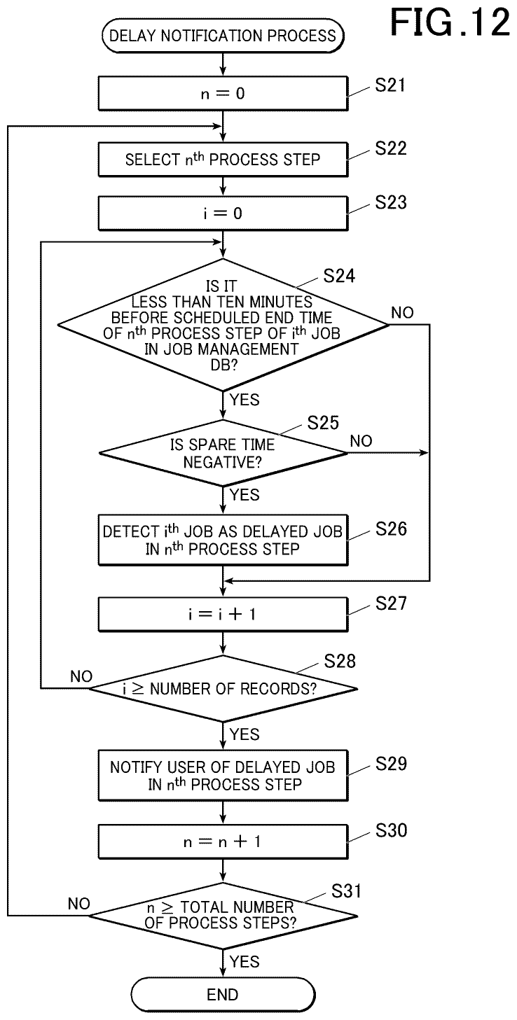

FIG. 12 is a flowchart illustrating the flow of the delay notification process. The delay notification process is performed by the controller 11 in cooperation with the print job management program 121 stored in the storage section 12. Note that numbers are given to process steps that may be performed for a job, in order from 0.

In the delay notification process, first, the controller 11 assigns 0 to a variable n (Step S21).

Next, the controller 11 selects the n^{th} process step in the job management DB 123 (Step S22).

Next, the controller 11 assigns 0 to a variable i (Step S23).

Next, the controller 11 determines whether it is less than ten minutes before the scheduled end time about the n^{th} process step of the i^{th} job in the job management DB 123 (Step S24). Note that the user can freely set, on the administrator terminal 4 or the like, how many minutes before the scheduled end time detection of delayed jobs is performed.

If the controller 11 determines that it is less than ten minutes before the scheduled end time about the n^{th} process step of the i^{th} job (Step S24; YES), the controller 11 determines whether the spare time in the n^{th} process step of the job is negative (Step S25).

If the controller 11 determines that the spare time is negative (Step S25; YES), the controller 11 detects the i^{th} job as a delayed job in the n^{th} process step, and stores the job ID, the scheduled end time and the spare time of the detected delayed job in the RAM (Step S26). Next, the controller 11 proceeds to Step S27.

In Step S24, if the controller 11 determines that it is not less than ten minutes before the scheduled end time about the n^{th} process step of the i^{th} job (Step S24; NO), the controller 11 proceeds to Step S27. In Step S25, if the controller 11 determines that the spare time in the n^{th} process step of the job is not negative (Step S25; NO), the controller 11 proceeds to Step S27.

In Step S27, the controller 11 increases the variable i by one (Step S27), and determines whether i is equal to or more than the number of records in the job management DB 123 (Step S28).

If the controller 11 determines that i is less than the number of records in the job management DB 123 (Step S28; NO), the controller 11 returns to Step S24.

If the controller 11 determines that i is equal to or more than the number of records in the job management DB 123 (Step S28; YES), the controller 11 notifies the user of the delayed job(s) in the n^{th} process step stored in the RAM (Step S29).

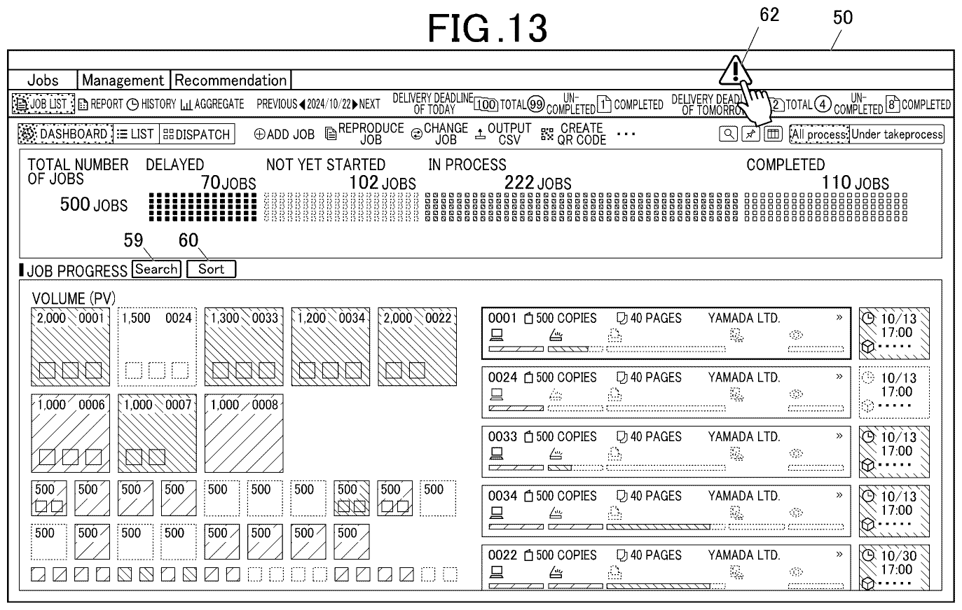

In Step S29, for example, the controller 11 causes each administrator terminal 4 displaying the job management screen 50 to display the warning mark 62 on the job management screen 50 as illustrated in FIG. 13. When receiving information indicating that the warning mark 62 has been pressed on the administrator terminal 4, the controller 11 causes the administrator terminal 4 to display a list of the process step names and the job IDs, the scheduled end times and the spare times of delayed jobs. Note that the delayed jobs about the process steps of which the user has been already notified in the current delay notification process may also be displayed.

Alternatively, the controller 11 may notify a mobile terminal of the administrator of the job IDs, the scheduled end times, the spare times and the like of delayed jobs by email or the like. Alternatively, on the job management screen 50, a notification to urge the user to press the warning mark 62 to check delayed jobs may be provided.

Next, the controller 11 increases the variable n by one (Step S30).

Next, the controller 11 determines whether the variable n is equal to or more than the total number of process steps (Step S31). If the controller 11 determines that the variable n is less than the total number of process steps (Step S31; NO), the controller 11 returns to Step S22. If the controller 11 determines that the variable n is equal to or more than the total number of process steps (Step S31; NO), the controller 11 ends the delay notification process.

Thus, in the delay notification process, delayed jobs delayed with respect to work plans are detected from among ordered jobs, and the user is notified of the information on the delayed jobs. Therefore, it is possible to reduce oversight of delayed jobs.

In the delay notification process illustrated in FIG. 12, the controller 11 detects and notifies the user of delayed jobs having a negative spare time, but may predict and notify the user of jobs having a risk of being delayed in the end even if they have a positive spare time at the time of detection. For example, even if the spare time at the time of detection is positive, the controller 11 may detect the job that is predicted to be delayed in the end from the progress rate from the start time to the current time, as a job having a delay risk and notify the user of the job.

As described above, in cooperation with the print job management program 121, the controller 11 of the management server 1 causes the administrator terminal 4 to display the progress statuses of jobs related to ordered printed materials with respect to their respective work plans and the volumes of the jobs on the job management screen 50 process step by process step in which the jobs are located. Therefore, the administrator can easily grasp whether a delayed job has occurred in a certain process step. Further, in a case where a delayed job has occurred, the progress statuses and the volumes of other jobs located in the same process step are displayed. Therefore, the administrator can quickly and easily modify work plans, for example, to allocate a person(s) and/or a machine(s) for the other job(s) to the delayed job.

Further, the controller 11 causes the administrator terminal 4 to display the progress statuses of jobs with respect to their respective work plans and the volumes thereof on the job management screen 50, wherein the jobs are each located in the process step same as or in a process step immediately before or after the process step of a specific delayed job and are progressing smoothly with respect to their respective work plans, and the specific delayed job is selected from among delayed jobs that are jobs delayed with respect to their respective work plans. Therefore, the administrator or the like can easily grasp other jobs that have a surplus capacity and whose personnel and/or machines can be allocated to a delayed job, and can quickly modify the work plan.

Further, the controller 11 sorts and causes the administrator terminal 4 to display the progress statuses of jobs with respect to their respective work plans and the volumes thereof in order of candidate for allocation of a person(s) or a machine(s) to the specific delayed job based on a predetermined condition on the job management screen 50, wherein the jobs are each located in the process step same as or in a process step immediately before or after the process step of a specific delayed job and are progressing smoothly with respect to their respective work plans, and the specific delayed job is selected from among delayed jobs that are jobs delayed with respect to their respective work plans. Therefore, the administrator can more quickly access other jobs that have a surplus capacity and whose personnel and/or machines can be allocated to a delayed job, and quickly modify the work plan.

Further, the controller 11 causes the administrator terminal 4 to display, on the job management screen 50 in a pop-up manner, about a job for which the work plan has been changed, the states and the spare times before and after the change of the work plan. Therefore, the administrator can check the change of the work plan, and can also check whether the change of the work plan will result in meeting the originally scheduled completion time. The administrator can check not only whether delay of a delayed job is resolved, but also influence on other jobs whose personnel and/or machines are provided to the delayed job.

Further, the controller 11 detects, from among the print jobs related to the ordered printed materials, a job delayed or a job having a risk of being delayed with respect to its work plan, and notifies the user of information on the detected job. Therefore, it is possible to reduce oversight of delayed jobs or jobs having a risk of being delayed.

Note that those described in the above embodiment are not limitations but some preferred examples of the present invention.

For example, although in the above embodiment, the job management screen 50 is displayed on the administrator terminal 4, the job management screen 50 may also be displayed on the worker terminal 3.

Further, although a hard disk, a semiconductor nonvolatile memory, or the like is used in the above embodiment as the computer-readable medium storing the programs according to the present invention, the computer-readable medium is not limited thereto. The computer-readable medium may be a portable recording medium such as a CD-ROM. Further, as a medium that provides data of the programs according to the present invention via a communication line, a carrier wave is also applied.

Besides, the detailed configuration and the detailed operation of the print job management system can be appropriately modified without departing from the scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A non-transitory computer-readable storage medium storing a program causing a computer to cause a display to display progress statuses of print jobs related to ordered printed materials with respect to work plans and volumes of the print jobs on a same screen process step by process step in which the print jobs are located.

2. The non-transitory computer-readable storage medium according to claim 1, wherein the program causes the computer to cause the display to display a progress status of at least one print job with respect to a work plan and a volume of the at least one print job on the same screen, wherein the at least one print job is located in a process step same as or in a process step immediately before or after a process step of a specific delayed job and is progressing smoothly with respect to the work plan, and the specific delayed job is one of the print jobs delayed with respect to the work plans.

3. The non-transitory computer-readable storage medium according to claim 1, wherein the program causes the computer to sort and causes the display to display a progress status of at least one print job with respect to a work plan and a volume of the at least one print job in order of candidate for allocation of a person or a machine to a specific delayed job based on a predetermined condition on the same screen, wherein the at least one print job is located in a process step same as or in a process step immediately before or after a process step of a specific delayed job and is progressing smoothly with respect to the work plan, and the specific delayed job is one of the print jobs delayed with respect to the work plans.

4. The non-transitory computer-readable storage medium according to claim 1, wherein the program causes the computer to cause the display to display, among the print jobs, about a print job whose work plan has been changed, states and spare times before and after the change of the work plan.

5. The non-transitory computer-readable storage medium according to claim 1, wherein the program causes the computer to detect, from among the print jobs related to the ordered printed materials, a print job delayed or a print job having a risk of being delayed with respect to a work plan, and performs notification of information on the detected print job.

6. A print job management apparatus comprising a hardware processor that causes a display to display progress statuses of print jobs related to ordered printed materials with respect to work plans and volumes of the print jobs on a same screen process step by process step in which the print jobs are located.

7. A print job management method that is performed by a computer, comprising causing a display to display progress statuses of print jobs related to ordered printed materials with respect to work plans and volumes of the print jobs on a same screen process step by process step in which the print jobs are located.
